(19) United States
(12) Patent Application Publication
(10) Pub. No.: US 2009/0191936 A1
(43) Pub. Date: Jul. 30, 2009

(54) GAMING SYSTEM, A GAME CONTROLLER, A PLAYER INTERFACE, AND A METHOD OF GAMING

(75) Inventor: Ryan Paul Hawkins, Coffs Harbour (AU)

Correspondence Address: HANLEY, FLIGHT & ZIMMERMAN, LLC, 150 S. WACKER DRIVE, SUITE 2100, CHICAGO, IL, 60606, US

(73) Assignee: ARISTOCRAT TECHNOLOGIES AUSTRALIA PTY LIMITED, Lane Cove (AU)

(21) Appl. No.: 12/199,421

(22) Filed: Aug. 27, 2008

(30) Foreign Application Priority Data
Aug. 28, 2007 (AU) 2007904684

(51) Int. Cl. A63F 9/24; A63F 13/00; G06F 19/00

(52) U.S. Cl. 463/16; 463/20; 463/37; 463/43

(57) ABSTRACT

A gaming system comprising: a touch screen display arranged to display a plurality of reels; and a game controller arranged to: control display of the plurality of reels; receive a signal from the touch screen display indicative that the touch screen display has been touched at a position corresponding to one of the reels; and alter the speed of rotation of at least one reel based on the signal.

### CROSS-REFERENCE TO RELATED APPLICATIONS

The present application claims the benefit of priority to Australian Provisional Patent Application No. 2007904684, filed on Aug. 28, 2007, entitled “GAMING SYSTEM, A GAME CONTROLLER, A PLAYER INTERFACE, AND A METHOD OF GAMING”, which is herein incorporated by reference in its entirety.

### FIELD

The presently described technology relates to a gaming system, a game controller, a player interface and a method of gaming.

### BACKGROUND

In video slot machine games, a plurality of reels are displayed such that they appear to spin as part of determining the game outcome. The speed of spinning of the reels is typically determined by the game designer.

There is an unmet need for a technique to enable a player to control the speed of spinning of the reels.

### BRIEF SUMMARY

In a first aspect, the invention provides a gaming system including:
a touch screen display arranged to display a plurality of reels; and
a game controller arranged to:
   control display of the plurality of reels;
   receive a signal from the touch screen display indicative that the touch screen display has been touched at a position corresponding to one of the reels; and
   alter the speed of rotation of at least one reel based on the signal.

In an embodiment, the game controller is arranged to alter the speed of rotation by applying an acceleration to the reel.

In an embodiment, the game controller is arranged to alter the speed of rotation by increasing the speed of rotation.

In an embodiment the game controller is arranged to process the signal to categorise the touch into one of a plurality of categories and apply different speed changes based on the categorisation.

In an embodiment, the game controller decreases the speed of rotation of the reels when the touch is categorised into a first category and increases the speed of rotation when the touch is categorised into a second category.

In an embodiment, the game controller is arranged to start at least one reel based on the signal.

In an embodiment, the signal is categorised based on a direction of movement of the touch relative to the reels.

In an embodiment, categorisation of the signal into the first category corresponds to determining that the touch was a movement against the direction of rotation of the reels.

In an embodiment, categorisation of the signal into the second category corresponds to determining that the touch was a movement with the direction of rotation of the reels.

In an embodiment, altering the speed of rotation of a reel alters the time for which it spins.

In an embodiment, the game controller includes a speed change module arranged to determine the speed alteration to be applied to the at least one reel.

In an embodiment, the game controller is arranged to apply the same speed alteration to each reel.

In a second aspect, the invention provides a game controller for a gaming system, the game controller arranged to:
control display of a plurality of reels on an associated touch screen display;
receive a signal from the touch screen display indicative that the touch screen display has been touched at a position corresponding to one of the reels; and
alter the speed of rotation of at least one reel based on the signal.

In an embodiment, the game controller is arranged to alter the speed of rotation by applying an acceleration to the reel.

In an embodiment, the game controller is arranged to alter the speed of rotation by increasing the speed of rotation.

In an embodiment, the game controller is arranged to process the signal to categorise the touch into one of a plurality of categories and apply different speed changes based on the categorisation.

In an embodiment, the game controller is arranged to decrease the speed of rotation of the reels when the touch is categorised into a first category and increase the speed of rotation when the touch is categorised into a second category.

In an embodiment, the game controller is arranged to start at least one reel based on the signal.

In an embodiment, the signal is categorised based on a direction of movement of the touch relative to the reels.

In an embodiment, categorisation of the signal into the first category corresponds to determining that the touch was a movement against the direction of rotation of the reels.

In an embodiment, categorisation of the signal into the second category corresponds to determining that the touch was a movement with the direction of rotation of the reels.

In an embodiment, altering the speed of rotation of a reel alters the time for which it spins.

In an embodiment, the game controller includes a speed change module arranged to determine the speed alteration to be applied to the at least one reel.

In an embodiment, the game controller is arranged to apply the same speed alteration to each reel.

In a third aspect, the invention provides a player interface for a gaming system; the player interface including a touch screen display arranged to display a plurality of reels and to receive a user input by touching at least one reel whereafter a speed alteration is applied to the speed of rotation of at least one displayed reel.

In an embodiment, the player interface is arranged to receive a plurality of different user inputs based on the touch applied by a user.

In a fourth aspect, the invention provides a method of gaming including:
displaying a plurality of reels to a player on a touch screen display;
determining that a player has touched the display at a position corresponding to at least one of the reels; and
altering the speed of rotation of the at least one reel touched by the player.

In an embodiment the method includes altering the speed of rotation by applying an acceleration to the reel.

In an embodiment, the method includes altering the speed of rotation by increasing the speed of rotation.

In an embodiment, the method includes categorising the touch into one of a plurality of categories and applying different speed changes based on the categorisation.

In an embodiment, the method includes decreasing the speed of rotation of the reels when the touch is categorised into a first category and increasing the speed of rotation when the touch is categorised into a second category.

In an embodiment, the method includes starting at least one reel based on the signal.

In an embodiment, the touch is categorised based on a direction of movement of the touch relative to the reels.

In an embodiment, categorisation of the touch into the first category corresponds to determining that the touch was a movement against the direction of rotation of the reels.

In an embodiment, categorisation of the touch into the second category corresponds to determining that the touch was a movement with the direction of rotation of the reels.

In an embodiment, altering the speed of rotation of a reel includes altering the time for which it spins.

In an embodiment, the method includes applying the same speed alteration to each reel.

In a fifth aspect, the invention provides computer program code which when executed implements the above method.

In a sixth aspect, the invention provides a computer readable medium including the program code.

In a seventh aspect, the invention provides a data signal including the program.

In an eight aspect, the invention extends to transmitting the program code.

### BRIEF DESCRIPTION OF THE DRAWINGS

Exemplary embodiments of the invention will now be described in relation to the following drawings in which:

FIG. 1 is a block diagram of the core components of a gaming system;

FIG. 2 is a perspective view of a gaming machine;

FIG. 3 is a block diagram of the functional components of a gaming machine;

FIG. 4 is a block diagram representing the structure of a memory;

FIG. 5 is a schematic diagram of a networked gaming system;

FIG. 6 is a further block diagram of a gaming system; and

FIG. 7 is a flowchart of an embodiment of the invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION

Referring to the drawings, there is shown a gaming system arranged to permit a player to alter the speed of rotation of reels of video slot machines. Gaming machines of the embodiment employ a touch screen display and allow a player to alter the speed of one or more reels. Advantageously, this enables the player to have a sensation of greater tactile interaction with the game.

In a first form, a stand alone gaming machine is provided wherein all or most components for implementing the game are present in a player operable gaming machine.

In a second form, a distributed architecture is provided wherein some of the components for implementing the game are present in a player operable gaming machine and some of the components for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

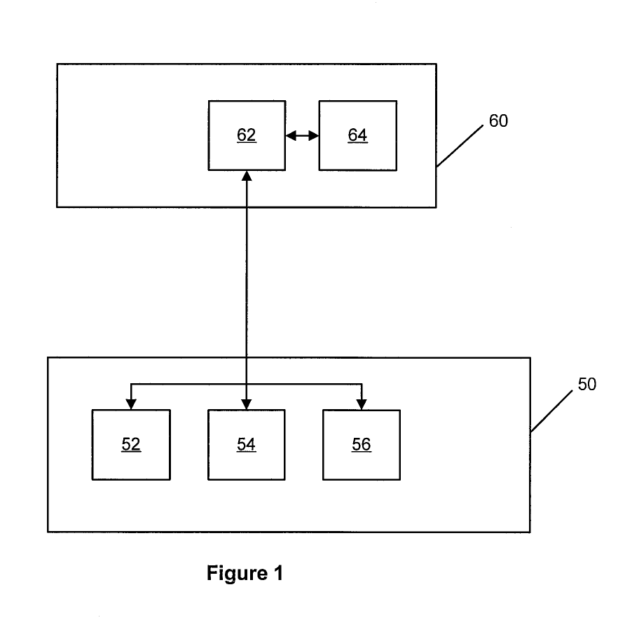

Irrespective of the form, the gaming system has several core components. At the broadest level, the core components are a player interface 50 and a game controller 60 as illustrated in FIG. 1. The player interface is arranged to enable manual interaction between a player and the gaming system and for this purpose includes the input/output components for the player to enter instructions and play the game.

Components of the player interface may vary from embodiment to embodiment but will typically include a credit mechanism 52 to enable a player to input credits and receive payouts, one or more displays 54 and a game play mechanism 56 that enables a player to input game play instructions.

The game controller 60 is in data communication with the player interface and typically includes a processor 62 that processes the game play instructions in accordance with game play rules and outputs game play outcomes to the display. Typically, the game play instructions are stored as program code in a memory 64 but can also be hardwired. Herein die term “processor” is used to refer generically to any device that can process game play instructions in accordance with game play rules and may include: a microprocessor, microcontroller, programmable logic device or other computational device, a general purpose computer (e.g. a PC) or a server.

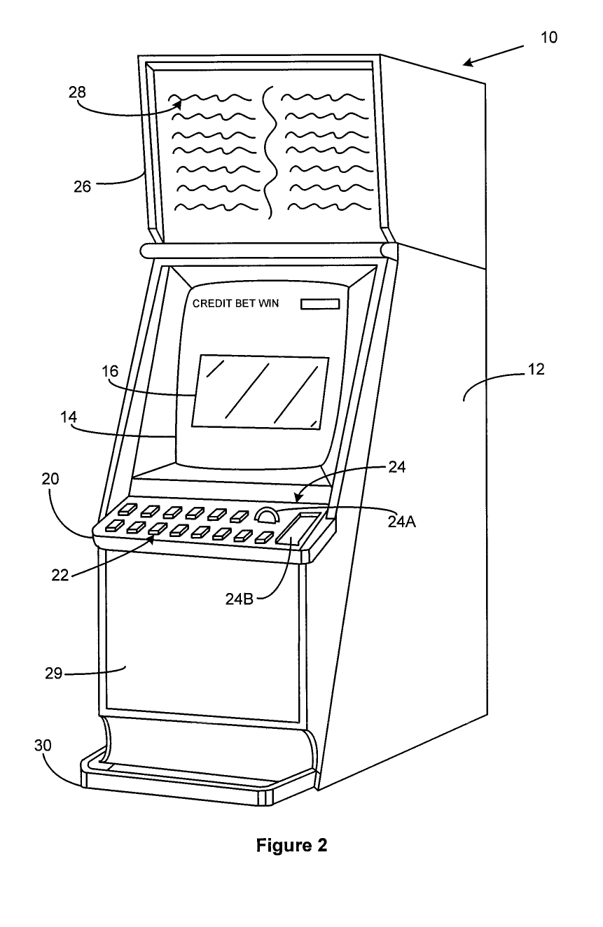

A gaming system in the form of a stand alone gaming machine 10 is illustrated in FIG. 2. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 2 is in the form of a video display unit, particularly a cathode ray tube screen device. Alternatively, the display 14 may be a liquid crystal display, plasma screen, any other suitable video display unit, or the visible portion of an electromechanical device. Displays of the embodiment are fitted with a touch screen. The top box 26 may also include a display, for example a video display unit, which may be of the same type as the display 14, or of a different type.

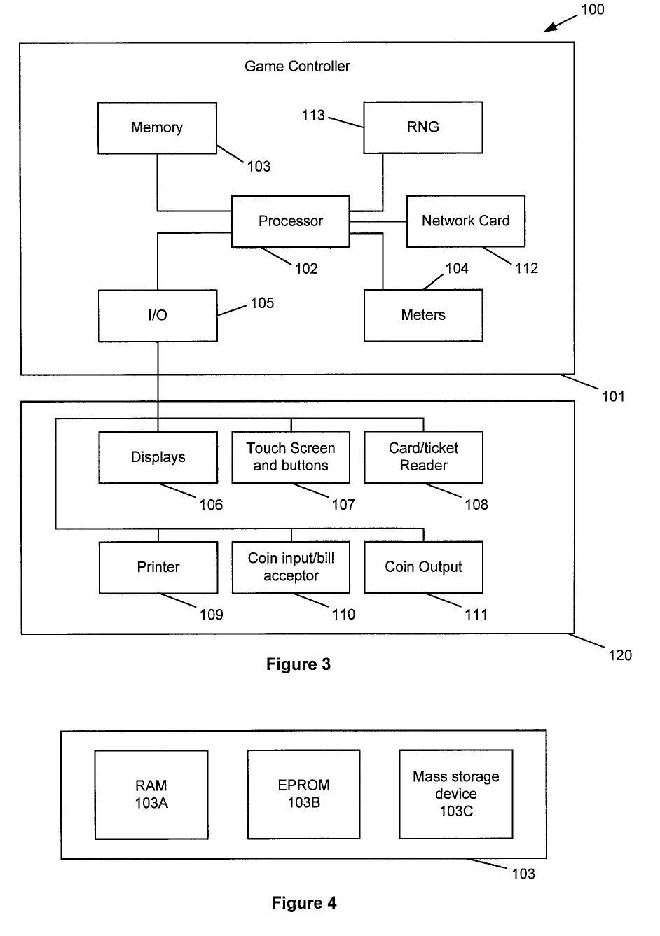

FIG. 3 shows a block diagram of operative components of a typical gaming machine which may be the same as or different to the gaming machine of FIG. 2.

The gaming machine 100 includes a game controller 101 having a processor 102. Instructions and data to control operation of the processor 102 are stored in a memory 103, which is in data communication with the processor 102. Typically, the gaming machine 100 will include both volatile and non-volatile memory and more than one of each type of memory, with such memories being collectively represented by the memory 103.

The gaming machine has hardware meters 104 for purposes including ensuring regulatory compliance and monitoring player credit, an input/output (I/O) interface 105 for communicating with peripheral devices of the gaming machine 100. The input/output interface 105 and/or the peripheral devices may be intelligent devices with their own memory for storing associated instructions and data for use with the input/output interface or the peripheral devices. A random number generator module 113 generates random numbers for use by the processor 102. Persons skilled in the art will appreciate that the reference to random numbers includes pseudo-random numbers.

In the example shown in FIG. 3, a player interface 120 includes peripheral devices that communicate with the game controller 101 including one or more displays 106, a touch screen and buttons 107, a card and/or ticket reader 108, a printer 109, a bill acceptor and/or coin input mechanism 110 and a coin output mechanism 111. Additional hardware may be included as part of the gaming machine 100, or hardware may be omitted depending upon the specific implementation.

In addition, the gaming machine 100 may include a communications interface, for example a network card 112. The network card may, for example, send status information, accounting information or other information to a central controller, server or database and receive data or commands from the central controller, server or database.

FIG. 4 shows a block diagram of the main components of an exemplary memory 103. The memory 103 includes RAM 103A, EPROM 103B and a mass storage device 103C. The RAM 103A typically temporarily holds program Eles for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

It is also possible for the operative components of the gaming machine 100 to be distributed, for example input/output devices 106,107,108,109,110,111 to be provided remotely from the game controller 101.

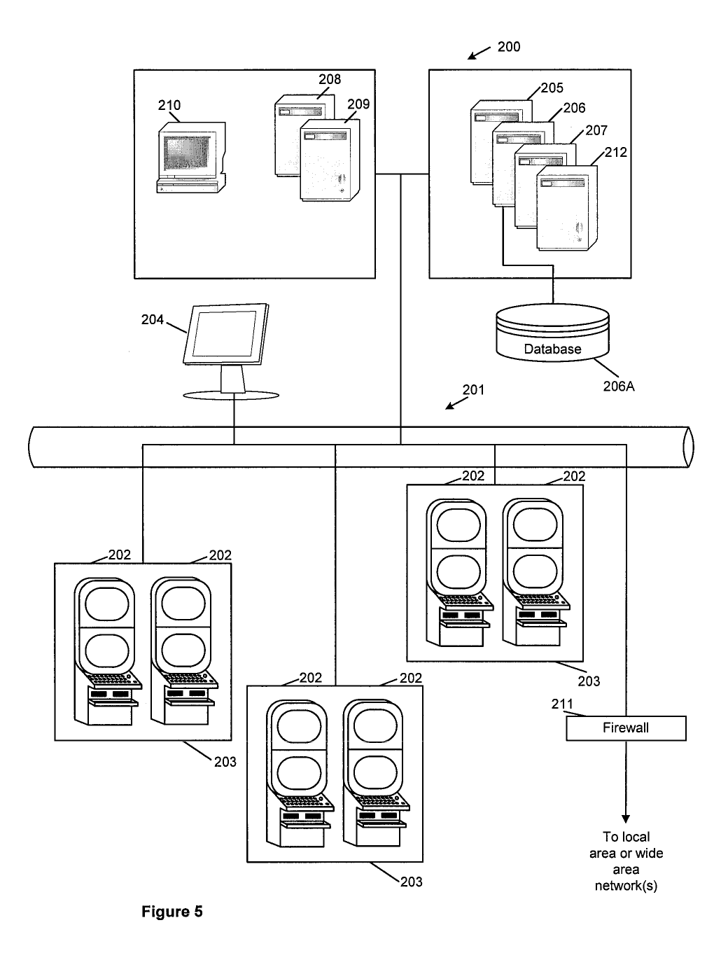

FIG. 5 shows a gaming system 200 in accordance with an alternative embodiment. The gaming system 200 includes a network 201, which for example may be an Ethernet network. Gaming machines 202, shown arranged in three banks 203 of two gaming machines 202 in FIG. 5, are connected to the network 201. The gaming machines 202 provide a player operable interface and may be the same as the gaming machines 10,100 shown in FIGS. 2 and 3, or may have simplified functionality depending on the requirements for implementing game play. While banks 203 of two gaming machines are illustrated in FIG. 5, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, game server 205 implements part of the game played by a player using a gaming machine 202 and the gaming machine 202 implements part of the game. With this embodiment, as both the game server and the gaming device implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game. The gaming network 200 also incorporates a player loyalty system 212.

In a thin client embodiment, game server 205 implements most or all of the game played by a player using a gaming machine 202 and the gaming machine 202 essentially provides only the player interface. With this embodiment, the game server 205 provides the game controller. The gaming machine will receive player instructions, pass these to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming network 200, including for example a gaming floor management server 208, and a licensing server 209 to monitor the use of licenses relating to particular games. An administrator terminal 210 is provided to allow an administrator to run the network 201 and the devices connected to the network.

The gaming network 200 may communicate with other gaming systems, other local networks, for example a corporate network, and/or a wide area network such as the Internet, for example through a firewall 211.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random generator engine. Alternatively, a separate random number generator server could be provided. Further, persons skilled in the art will appreciate that a plurality of games servers could be provided to run different games or a single game server may run a plurality of different games based on the involved terminals.

In a typical video slot machine once a player places a wager or presses a play button, the game controller 60 controls the reels to spin. Typically the spin routine is arranged to emulate the spinning of a physical reel. Accordingly, typically the reels will begin moving from a stopped position corresponding to the previous game outcome, accelerate to a maximum speed and decelerate to a stop. The length of time for which the reels are spun will vary from game to game. In some games, the reels are spun so that it appears that the number of symbols that pass by on the display correspond to a predetermined number of rotations of the reel. That is, the symbols on the reel define a sequence and spinning may occur such that that all of the symbols are displayed at least twice. In other embodiments, the reels are spun for a predetermined time.

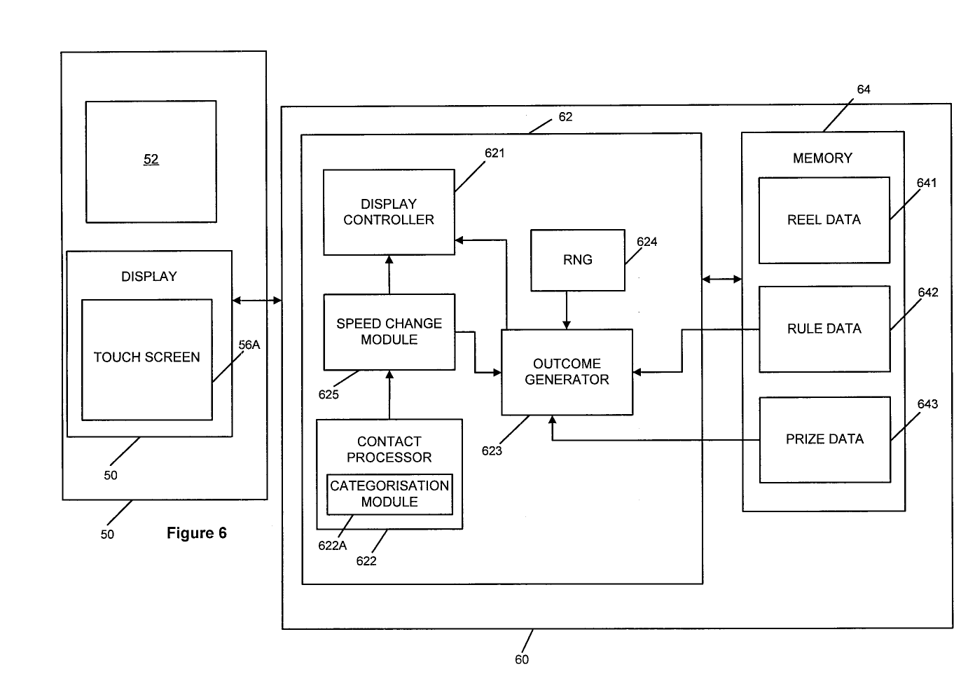

A gaming system is shown in more detail in FIG. 6. As shown in FIG. 6, display 54 includes a touch screen 56A to thereby provide a touch screen display.

In FIG. 6, the processor 62 is shown as implementing a plurality of modules 621, 622, 623 and 624. Persons skilled in the art will appreciate that not all modules need be implemented by a processor 62. For example, the display controller 621 can be provided by a dedicated graphics card operating independently of processor 62.

The game controller 60 has a display controller 621 which controls the display on the basis of reel data 641 to display a plurality of reels to a player of a game. A contact processor 622 is arranged to monitor the output of the touch screen 56A and to process signals received from the touch screen to determine that contact has been detected by the touch screen 56A of display 54 relevant to spinning of the reels, and to categorise the nature of the contact into a first category corresponding to an increase in speed and a second category corresponding to a decrease in speed.

Categorisation module 622A of Contact monitor 622 provides data describing at least the category and the reel that was touched to the speed change module 625 which determines a speed change for the touched reel and provides data to the display controller that enables it to control the display 54 to display the reels moving at the modified speed.

A modification to the speed can be achieved in a number of different ways. In the embodiment, the speed change module 625 is arranged to apply an acceleration to the current speed of the reels to increase or decrease the speed of the reels and hence to change the time taken by the reels to stop on the display. Once the reels stop, any prize corresponding to the outcome is displayed to the player.

Persons skilled in the art will appreciate that a number of variations may be applied to the above embodiment, for example, in one embodiment only increases of speed may be applied to the reels. In such embodiments, there is no need for the categorisation module, as it is only necessary for the contact processor 622 to determine that the player has touched the reels to apply a speed change. In other embodiments, the contact processor 622 may determine from processing the touch screen output signal that there has been continuous contact of the screen by the player as they drag their finger across the screen from a first position to a second position and determine based on the signal which direction the player moved their finger relative to the reels. The contact processor may then categorise the movements into movements which act against the direction of spin of the reels or movements that go with the spin of the reels and apply “common sense” speed changes such that moving against the spin of the reel acts to brake the reel whereas moving in the direction of the reel acts to increase the speed of the reel. Persons skilled in the art will appreciate that variations are possible. For example, in one embodiment a movement relative to the display may be involved in order to increase the speed of the reel whereas touching the screen at one place will act to brake the reel.

In still other embodiments, the contact processor 622 may determine the velocity of a touching movement on the touch screen and provide data describing this velocity to the speed change module 625 to enable the speed change module to determine a degree of speed change of the reels.

In a further embodiment, the player may start the spinning of the reels by touching a reel. That is, the player initiates play of the game by manually starting spinning of the reels by touching the display. In this embodiment, the contact processor sends data to the outcome generator 623 to advise it to generate an outcome from reel data 641 rule data 642 and prize data 64B based on reel stop positions determined employing the random number generator 624 when it is determined that the player has begun spinning the reel using the touch screen. In this embodiment, the capability to start play with the touch screen may be supplemented by a “play” button for players who wish to start the game in a conventional manner.

Depending on the implementation, touching one of the reels may control the speed of only the touched reel or it may control the speed of more than one reel or all of the reels, for example all of the reels or reels which have yet to stop.

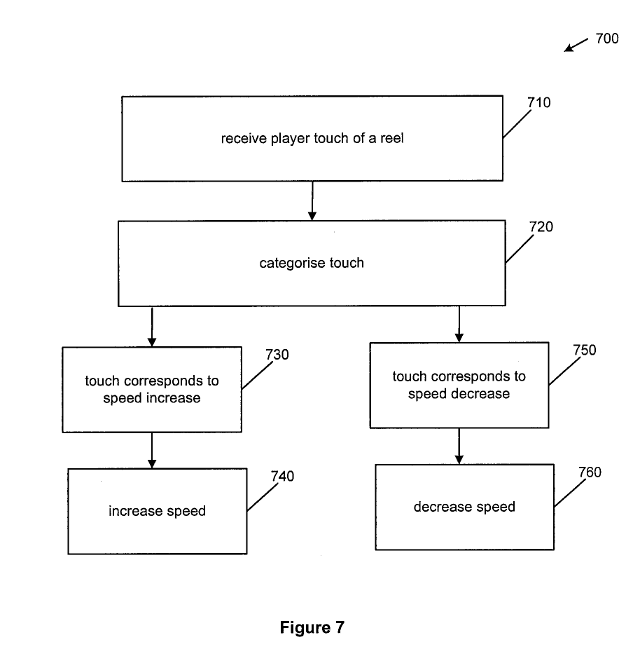

The method of the present invention is summarised in FIG. 7. A player touch of a reel is received 710. The touch is categorised 720 either into a first a category where the touch corresponds to a speed increase 730 which results in an increase in speed 740 or a second category 750 which corresponds to a speed decrease 750 and results in a decrease in speed 760.

Persons skilled in the art will appreciate that variations may be made to the invention without departing from the scope of the invention. For example, in further embodiments there may be more than two categories for speed changes that can be applied. For example, speed changes may be applied incrementally based on the number of the touches on the displays such that a first touch increases speed by a first margin, a second touch increases the speed by a second margin and a third touch increases the speed by a third margin etc., with categories corresponding to each possible speed variation.

Persons skilled in the art will also appreciate that the method of the embodiment could be embodied in program code. The program code could be supplied in a number of ways, for example on a computer readable medium, such as a disc or a memory (for example, that could replace part of memory 103) or as a data signal (for example, by downloading it from a server).

It will be understood to persons skilled in the art of the invention that many modifications may be made without departing from the spirit and scope of the invention, in particular it will be apparent that certain features of embodiments of the invention can be employed to form further embodiments.

It is to be understood that, if any prior art is referred to herein, such reference does not constitute an admission that the prior art forms a part of the common general knowledge in the art in any country.

In the claims which follow and in the preceding description of the invention, except where the context indicates otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

Several embodiments are described above with reference to the drawings. These drawings illustrate certain details of specific embodiments that implement the systems and methods and programs of the present invention. However, describing the invention with drawings should not be construed as imposing on the invention any limitations associated with features shown in the drawings. The present invention contemplates methods, systems and program products on any electronic device and/or machine-readable media suitable for accomplishing its operations. As noted above, certain embodiments of the present invention may be implemented using an existing computer processor and/or by a special purpose computer processor incorporated for this or another purpose or by a hardwired system, for example.

As noted above, embodiments within the scope of the present invention include program products comprising machine-readable media for carrying or having machine-executable instructions or data structures stored thereon. Such machine-readable media can be any available media that can be accessed by a general purpose or special purpose computer or other machine with a processor. By way of example, such machine-readable media may comprise RAM, ROM, PROM, EPROM, EEPROM, Flash, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Certain embodiments of the invention are described in the general context of method steps which may be implemented in one embodiment by a program product including machine-executable instructions, such as program code, for example in the form of program modules executed by machines in networked environments. Generally, program modules include routines, programs, objects, components, data structures, etc., that perform particular tasks or implement particular abstract data types. Machine-executable instructions, associated data structures, and program modules represent examples of program code for executing steps of the methods disclosed herein. The particular sequence of such executable instructions or associated data structures represents examples of corresponding acts for implementing the functions described in such steps.

1. A gaming system comprising:
a touch screen display arranged to display a plurality of reels; and
a game controller arranged to:
control display of the plurality of reels;
receive a signal from the touch screen display indicative that the touch screen display has been touched at a position corresponding to one of the reels; and
alter the speed of rotation of at least one reel based on the signal.

2. A gaming system as claimed in claim 1, wherein the game controller is arranged to alter the speed of rotation by applying an acceleration to the reel.

3. A gaming system as claimed in claim 1, wherein the game controller is arranged to alter the speed of rotation by increasing the speed of rotation.

4. A gaming system as claimed in claim 1, wherein the game controller is arranged to process the signal to categorise the touch into one of a plurality of categories and apply different speed changes based on the categorisation.

5. A gaming system as claimed in claim 4, wherein the game controller decreases the speed of rotation of the reels when the touch is categorised into a first category and increases the speed of rotation when the touch is categorised into a second category.

6. A gaming system as claimed in claim 1, wherein the game controller is arranged to start at least one reel based on the signal.

7. A gaming system as claimed in claim 4, wherein the signal is categorised based on a direction of movement of the touch relative to the reels.

8. A gaming system as claimed in claim 5, wherein categorisation of the signal into the first category corresponds to determining that the touch was a movement against the direction of rotation of the reels.

9. A gaming system as claimed in claim 5, wherein categorisation of the signal into the second category corresponds to determining that the touch was a movement with the direction of rotation of the reels.

10. A gaming system as claimed in claim 1, wherein altering the speed of rotation of a reel alters the time for which it spins.

11. A gaming system as claimed in claim 1, wherein the game controller comprises a speed change module arranged to determine the speed alteration to be applied to the at least one reel.

12. A gaming system as claimed in claim 1, wherein the game controller is arranged to apply the same speed alteration to each reel.

13. A game controller for a gaming system, the game controller arranged to:
control display of a plurality of reels on an associated touch screen display;
receive a signal from the touch screen display indicative that the touch screen display has been touched at a position corresponding to one of the reels; and
alter the speed of rotation of at least one reel based on the signal.

14. A game controller as claimed in claim 13, arranged to alter the speed of rotation by applying an acceleration to the reel.

15. A game controller as claimed in claim 13, arranged to alter the speed of rotation by increasing the speed of rotation.

16. A game controller as claimed in claim 13, arranged to process the signal to categorise the touch into one of a plurality of categories and apply different speed changes based on the categorisation.

17. A game controller as claimed in claim 13, arranged to decrease the speed of rotation of the reels when the touch is categorised into a first category and increase the speed of rotation when the touch is categorised into a second category.

18. A game controller as claimed in 13, arranged to start at least one reel based on the signal.

19. A game controller as claimed in claim 16, wherein the signal is categorised based on a direction of movement of the touch relative to the reels.

20. A game controller as claimed in claim 17, wherein categorisation of the signal into the first category corresponds to determining that the touch was a movement against the direction of rotation of the reels.

21. A game controller as claimed in claim 17, wherein categorisation of the signal into the second category corresponds to determining that the touch was a movement with the direction of rotation of the reels.

22. A game controller as claimed in claim 13, wherein altering the speed of rotation of a reel alters the time for which it spins.

23. A game controller as claimed in claim 13, comprising a speed change module arranged to determine the speed alteration to be applied to the at least one reel.

24. A game controller as claimed in claim 1, arranged to apply the same speed alteration to each reel.

25. A player interface for a gaming system; the player interface comprising a touch screen display arranged to display a plurality of reels and to receive a user input by touching at least one reel whereafter a speed alteration is applied to the speed of rotation of at least one displayed reel.

26. A player interface as claimed in claim 25 arranged to receive a plurality of different user inputs based on the touch applied by a user.

27. A method of gaming comprising:
displaying a plurality of reels to a player on a touch screen display;
determining that a player has touched the display at a position corresponding to at least one of the reels; and
altering the speed of rotation of the at least one reel touched by the player.

28. A method as claimed in claim 27, comprising altering the speed of rotation by applying an acceleration to the reel.

29. A method as claimed in claim 27, comprising altering the speed of rotation by increasing the speed of rotation.

30. A method as claimed in claim 27, comprising categorising the touch into one of a plurality of categories and apply different speed changes based on the categorisation.

31. A method as claimed in claim 30, comprising decreasing the speed of rotation of the reels when the touch is categorised into a first category and increasing the speed of rotation when the touch is categorised into a second category.

32. A method as claimed in claim 27, comprising starting at least one reel based on the signal.

33. A method as claimed in claim 30, wherein the touch is categorised based on a direction of movement of the touch relative to the reels.

34. A method as claimed in claim 33, wherein categorisation of the touch into the first category corresponds to determining that the touch was a movement against the direction of rotation of the reels.

35. A method as claimed in claim 33, wherein categorisation of the touch into the second category corresponds to determining that the touch was a movement with the direction of rotation of the reels.

36. A method as claimed in claim 27, wherein altering the speed of rotation of a reel comprises altering the time for which it spins.

37. A method as claimed in claim 27, comprising applying the same speed alteration to each reel.

38. A computer readable medium comprising computer program code which when executed implements the method of claim 27.
